(19) United States
(12) Patent Application Publication
(10) Pub. No.: US 2009/0034761 A1
(43) Pub. Date: Feb. 5, 2009

(54) ELECTROSTATIC SPEAKER

(76) Inventors: Takao NAKAYA, Hamamatsu-shi (JP); Yasuaki Takano, Kikugawa-shi (JP)

Correspondence Address: SMITH PATENT OFFICE, 1901 PENNSYLVANIA AVENUE N W, SUITE 901, WASHINGTON, DC, 20006, US

(21) Appl. No.: 12/181,044

(22) Filed: Jul. 28, 2008

(30) Foreign Application Priority Data
Aug. 2, 2007 (JP) P 2007-201862

(51) Int. Cl. H04R 19/00

(52) U.S. Cl. 381/191

(57) ABSTRACT

An electrostatic speaker is constituted of a vibrator held between opposite electrodes via spacers. The vibrator has a plurality of surface projections and a plurality of backside projections, which project in opposite directions. When voltage differences occur between the opposite electrodes due to audio signals, electrostatic force is exerted on the vibrator, which thus vibrates in response to audio signals with a high sensitivity. The vibrator 10 generates sound in response to vibration parameters such as vibration frequency, amplitude, and phase. The sound propagates through at least one of the opposite electrodes having small holes and is thus emitted to the external space. Thus, it is possible to precisely reproduce sound with a high sensitivity to audio signals and without causing distortions in reproduction waves.

### BACKGROUND OF THE INVENTION

1. Field of the Invention

The present invention relates to electrostatic speakers each constituted of two parallel-plate electrodes holding a vibrator (or a vibrating member) therebetween.

The present application claims priority on Japanese Patent Application No. 2007-201862, the content of which is incorporated herein by reference.

2. Description of the Related Art

Conventionally, electrostatic speakers have been well known and disclosed in various documents such as Patent Document 1 and Patent Document 2.
Patent Document 1: Japanese Unexamined Patent Application Publication No. H11-178098
Patent Document 2: Japanese Patent Application Publication No. 2002-532994

A typical example of an electrostatic speaker is constituted of two parallel-plate electrodes, which are positioned opposite to each other with a prescribed distance therebetween, and a vibrator having a sheet-like shape and conductive property, which is inserted between the two parallel-plate electrodes and both ends of which are supported by a housing. When a voltage applied to the two parallel-plate electrodes is varied while a prescribed bias voltage is applied to the vibrator, electrostatic force exerted on the vibrator is varied so as to cause a displacement of the vibrator. When the applied voltage is varied in response to audio signals, displacement repeatedly occurs in the vibrator which thus vibrates and produces reproduction waves corresponding to audio signals. Reproduction waves are emitted to the external space via holes of the parallel-plate electrodes.

Electrostatic force exerted on the vibrator of the electrostatic speaker varies in inverse proportion to the square of the distance between the vibrator and the parallel-plate electrodes. In order to cause vibration of the vibrator with a high sensitivity, it is necessary to reduce the distance between the vibrator and the parallel-plate electrodes. Patent Document 2 teaches the technology for reducing the distance between the vibrator and the parallel-plate electrodes in an electrostatic speaker. A plurality of linear projections are formed in the vibrator of the electrostatic speaker disclosed in Patent Document 2, wherein the top portions of the linear projections of the vibrator come in contact with the parallel-plate electrodes. This reduces the distance between the vibrator and the parallel-plate electrodes, thus allowing the vibrator to vibrate with a high sensitivity.

As described above, the electrostatic speaker of Patent Document 2 is designed to improve the sensitivity by reducing the distance between the parallel-plate electrodes positioned opposite to each other. However, when the distance between the opposite electrodes is reduced, the drive force due to audio signals increases so that the opposite electrodes must be excessively driven to vibrate. This may cause distortions in reproduction waves produced by the electrostatic speaker.

### SUMMARY OF THE INVENTION

It is an object of the present invention to provide an electrostatic speaker in which a vibrator sandwiched between opposite electrodes vibrates with a high sensitivity without causing distortions in reproduction waves.

An electrostatic speaker of the present invention includes a first electrode having conductive properties, a second electrode having conductive properties, which is positioned opposite to the first electrode with a prescribed distance therebetween, a vibrator inserted between the first electrode and the second electrode, in which the vibrator has a plurality of first projections projecting towards the first electrode and a plurality of second projections projecting towards the second electrode, and a support member for supporting the vibrator. Each of the first projections has a polygonal cross-sectional shape or a closed-curve-like cross-sectional shape. Each of the second projections has a polygonal cross-sectional shape or a closed-curve-like shape. In addition, the first projections and the second projections are regularly aligned in connection with the vibrator.

In the above, both of the first projections and the second projections have the same height. Both of the first projections and the second projections have the same shape. The support member supports the vibrator without applying tension to the vibrator.

In addition, the distance between the first electrode and the distal end of the first projection is identical to the distance between the second electrode and the distal end of the second projection.

It is possible to insert a first elastic member between the first electrode and the vibrator to insert a second elastic member between the second electrode and the vibrator.

The first projection has a planar distal end which is positioned in parallel to the first electrode, and the second projection has a planar distal end which is positioned in parallel to the second electrode. Both the planar distal end of the first projection and the planar distal end of the second projection have the same area. In addition, the number of the first projections is identical to the number of the second projections.

As described above, the electrostatic speaker of the present invention allows the vibrator to vibrate with a high sensitivity in response to audio signals, thus precisely producing reproduction waves without distortions.

### BRIEF DESCRIPTION OF THE DRAWINGS

These and other objects, aspects, and embodiments of the present invention will be described in more detail with reference to the following drawings.

FIG. 1 is a perspective view showing an electrostatic speaker including a vibrator held between opposite electrodes in accordance with a preferred embodiment of the present invention;

FIG. 2 is a longitudinal sectional view of the electrostatic speaker;

FIG. 3 is an exploded perspective view of the electrostatic speaker;

FIG. 4A is a cross-sectional view diagrammatically showing projections having conical shapes, which are formed in the vibrator of the electrostatic speaker;

FIG. 4B is a cross-sectional view diagrammatically showing projections having trapezoidal shapes, which are formed in the vibrator of the electrostatic speaker;

FIG. 4C is a cross-sectional view diagrammatically showing projections having triangular waveform-like shapes, which are formed in the vibrator of the electrostatic speaker;

FIG. 4D is a cross-sectional view diagrammatically showing projections having circular waveform-like shapes, which are formed in the vibrator of the electrostatic speaker;

FIG. 5A is a cross-sectional view diagrammatically showing projections having rectangular step-like shapes, which are formed in the vibrator of the electrostatic speaker;

FIG. 5B is a cross-sectional view diagrammatically showing projections having trapezoidal step-like shape, which are formed in the vibrator of the electrostatic speaker;

FIG. 5C is a cross-sectional view diagrammatically showing projections having circular step-like shapes, which are formed in the vibrator of the electrostatic speaker;

FIG. 6 is a longitudinal sectional view showing a variation of the electrostatic speaker in which elastic members are inserted between the vibrator and the opposite electrodes; and

FIG. 7 is a longitudinal sectional view showing another variation of the electrostatic speaker in which the elastic members are not partially embedded in recesses formed by the projections of the vibrator.

### DESCRIPTION OF THE PREFERRED EMBODIMENT

The present invention will be described in further detail by way of examples with reference to the accompanying drawings.

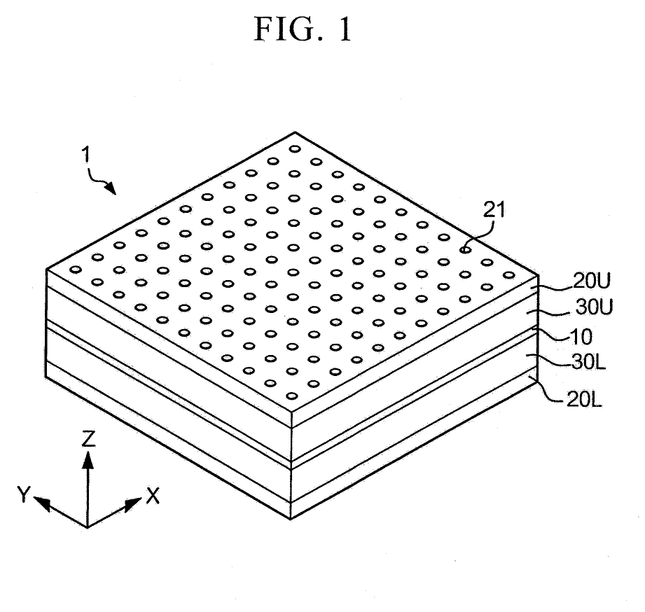

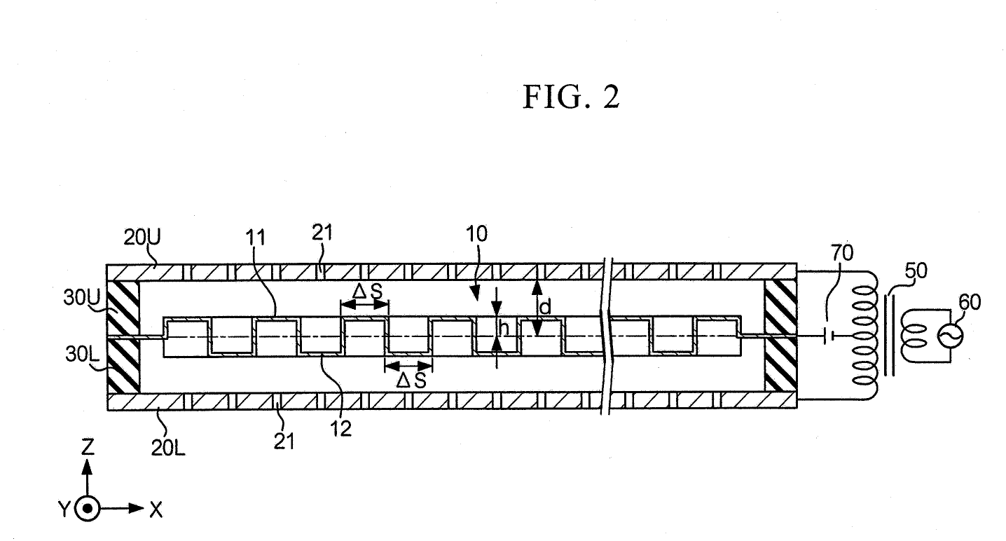

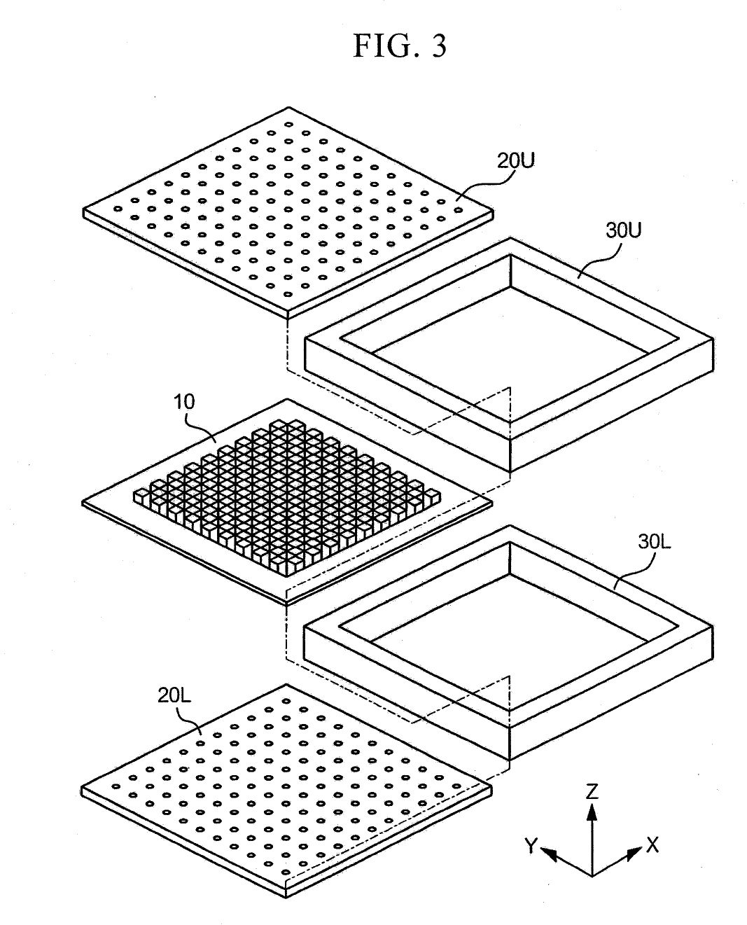

FIG. 1 is a perspective view diagrammatically showing the exterior appearance of an electrostatic speaker 1 in accordance with a preferred embodiment of the present invention. FIG. 2 is a longitudinal sectional view of the electrostatic speaker 1. FIG. 3 is an exploded perspective view of the electrostatic speaker 1.

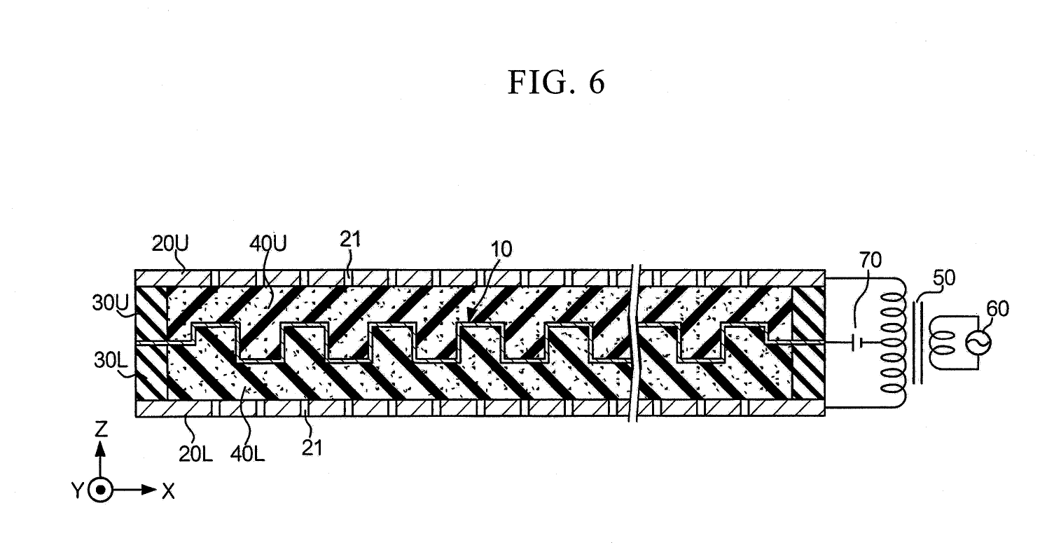

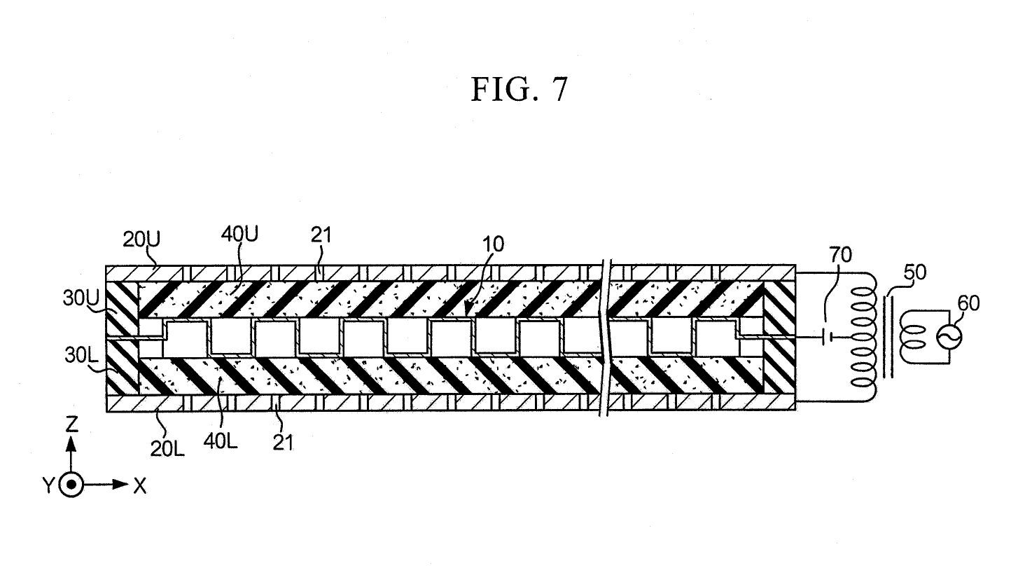

The electrostatic speaker 1 is constituted of a vibrator 10, a pair of electrodes 20U and 20L (which are positioned opposite to each other with the vibrator 10 therebetween), and a pair of spacers 30U and 30L. For the sake of convenience, reference numerals 20U and 20L are simply represented by “20”, and reference numerals 30U and 30L are simply represented by “30” because both the electrodes 20U and 20L have the same constitution, and both the spacers 30U and 30L have the same constitution. In FIGS. 1 to 3, constituent elements (e.g. the vibrator 10, the electrodes 20, and the spacers 30) of the electrostatic speaker 1 are not always drawn with precise dimensions practically adapted to products. In addition, a circle with a dot in FIG. 2 (and FIGS. 6 and 7) shows an arrow (lying in a Y-axis direction) which is directed from the backside to the surface of each sheet of an illustration.

The vibrator 10 is formed by depositing a metal film on a film composed of PET (i.e. polyethylene terephthalate) or PP (polypropylene) or by applying a conductive material onto the film, wherein the thickness thereof ranges from several micro-meters to several tens of micro-meters. The vibrator 10 has a planar peripheral portion and includes a plurality of surface projections 11 and a plurality of backside projections 12 formed in an internal portion thereof. The surface projections 11 project in one direction from an X-Y plane of the vibrator 10, while the backside projections 12 project in another direction from the X-Y plane of the vibrator 10. In the vibrator 10, the surface projections 11 and the backside projections 12 are alternately and regularly aligned in both of the X-axis direction and Y-axis direction. In view of a cross section of the vibrator 10 which is subjected to cutting along an X-Z plane, as shown in FIG. 2, the vibrator 10 is shaped like square waves. In view of another cross section of the vibrator 10 subjected to cutting along the X-Y plane, each of the surface projections 11 and the backside projections 12 has a square cross-sectional shape.

The electrode 20 having a conductive property is formed in a rectangular plate-like shape. In order to secure an acoustic transmission ability of the electrode 20, a plurality of holes 21 running through the electrode 20 is formed with prescribed distances therebetween. In the present embodiment, the electrode 20 is formed in a square shape having the same length in both the X-axis and Y-axis directions, while the vibrator 10 is also formed in a square shape having the same length in both the X-axis and Y-axis directions.

The spacer 30 composed of an insulating material is formed in a rectangular enclosure-like shape having four corners as shown in FIG. 3. Herein, the X-axis length and Y-axis length of the spacer 30 are substantially identical to the X-axis length and Y-axis length of the electrode 20. In addition, both the spacers 30U and 30L have the same Z-axis height.

In the electrostatic speaker 1, the spacer 30L is fixed onto the peripheral portion of the electrode 20L, and the peripheral portion of the vibrator 10 is fixed onto the spacer 30L. Herein, the vibrator 10 is fixed onto the spacer 30L without bearing tension applied thereto. In addition, the spacer 30U is fixed onto the peripheral portion of the vibrator 10, and the peripheral portion of the electrode 20U is fixed onto the spacer 30U.

In the above structure, the electrodes 20U and 20L are positioned opposite to each other so as to sandwich the vibrator 10 therebetween and are fixed to the spacers 30U and 30L, wherein the vibrator 10 is supported to vertically vibrate in the Z-axis direction within the space defined between the electrodes 20U and 20L.

Next, the electric constitution of the electrostatic speaker 1 will be described in detail. FIG. 2 shows an equivalent circuit adapted to the electrostatic speaker 1, which includes a transformer 50, an input portion 60 for inputting audio signals from an external portion (not shown), and a bias voltage source 70 for applying a DC bias voltage to the vibrator 10. The bias voltage source 70 is connected between the vibrator 10 and a midpoint of the transformer 50, while the electrodes 20U and 20L are connected to opposite ends of the transformer 50. In this electric constitution, when audio signals are applied to the input portion 60, corresponding voltages are applied to the vibrator 10 and the electrodes 20U and 20L.

Due to a voltage difference occurring between the electrodes 20U and 20L, electrostatic force is exerted on the vibrator 10, which is thus attracted to the electrode 20U or 20L. That is, displacement (or deflection) occurs in the vibrator 10 in the Z-axis direction in response to audio signals, wherein the displacement may successively vary in direction so as to cause a vibration; hence, the vibrator 10 produces sound in response to vibration parameters such as the vibration frequency, amplitude, and phase. The sound propagates through at least one of the electrodes 20U and 20L and is thus emitted to the external space of the electrostatic speaker 1.

Compared with the conventionally-known electrostatic speaker having a planar vibrator sandwiched between opposite electrodes, the electrostatic speaker 1 of the present embodiment is designed such that the vibrator 10 has the surface projections 11 projecting towards the electrode 20U and the backside projections 12 projecting towards the electrode 20L. For this reason, even when the distance between the electrodes 20U and 20L is identical to the distance between the opposite electrodes of the conventionally-known electrostatic speaker, relatively short distances are provided between the distal ends of the projections 11 and 12 of the vibrator 10 and the electrodes 20 in the electrostatic speaker 1 in comparison with the conventionally-known electrostatic speaker, whereby it is possible to improve the sensitivity of the vibrator 10.

Specifically, the above features of the present embodiment can be proved by way of mathematical expressions in which d denotes the distance between the center of the vibrator 10 and the electrode 20 in the Z-axis direction, h denotes the height in the Z-axis direction between the distal end of the surface projection 11 and the center of the vibrator 10 and between the distal end of the backside projection 12 and the center of the vibrator 10, and ΔS (i.e. ΔS₁, ΔS₂, . . . ) denotes the area of the distal end of the surface projection 11 and the area of the distal end of the backside projection 12. A force F applied to the vibrator 10 by one of the electrodes 20 is expressed by an equation (1), while the overall area S corresponding to the sum of the areas of the distal ends of the projections 11 and 12 is expressed by an equation (2), wherein n denotes the total number of the projections 11 and 12.

$$\begin{matrix}F \approx \frac{1}{{( d - h )}^{2}} Δ {S}_{1} + \frac{1}{{( d + h )}^{2}} Δ {S}_{2} + … & ( 1 ) \\ {\sum }_{n = 1}^{n} Δ {S}_{n} = S & ( 2 )\end{matrix}$$

The equation (1) is subjected to expansion into power series as expressed in equations (3).

$$\frac{1}{{( d + h )}^{2}} = \frac{1}{{d}^{2}} - \frac{2 h}{{d}^{3}} + \frac{3 {h}^{2}}{{d}^{4}} - \frac{4 {h}^{3}}{{d}^{5}} + … \\ \frac{1}{{( d - h )}^{2}} = \frac{1}{{d}^{2}} + \frac{2 h}{{d}^{3}} + \frac{3 {h}^{2}}{{d}^{4}} + \frac{4 {h}^{3}}{{d}^{5}} + … \qquad ( 3 )$$

Suppose that the area of the distal end of the surface projection 11 is identical to the area of the distal end of the backside projection 12, the overall area of the projections 11 or 12 lying on one side of the vibrator 10 is ½S; hence, the force F applied to the vibrator 10 by one electrode 20 is expressed by an equation (4).

$$\begin{matrix}F = \frac{S}{2} ( \frac{1}{{d}^{2}} - \frac{2 h}{{d}^{3}} + \frac{3 {h}^{2}}{{d}^{4}} - \frac{4 {h}^{3}}{{d}^{5}} + … ) + \\ \frac{S}{2} ( \frac{1}{{d}^{2}} + \frac{2 h}{{d}^{3}} + \frac{3 {h}^{2}}{{d}^{4}} + \frac{4 {h}^{3}}{{d}^{5}} + … ) \\ = S ( \frac{1}{{d}^{2}} + \frac{3 {h}^{2}}{{d}^{4}} + \frac{5 {h}^{4}}{{d}^{6}} + … )\end{matrix} \qquad ( 4 )$$

When d=0.5 mm, F=4 is calculated for the planar vibrator (having no projection) used in the conventionally-known electrostatic speaker (where h=0 mm). When d=0.5 mm and h=0.17 mm, F=5.58 is calculated for the vibrator 10 having the projections 11 and 12 in the electrostatic speaker 1 of the present embodiment. Compared with the conventionally-known electrostatic speaker, the electrostatic speaker 1 of the present embodiment improved by about 3 dB in sensitivity due to the projections 11 and 12 of the vibrator 10.

In the present embodiment, it is possible to increase the rigidity of the vibrator 10 (having the projections 11 and 12) compared with the planar vibrator. This makes it difficult to form lines and bags in the vibrator 10 even when no tension is applied to the vibrator 10 in manufacturing. Thus, electrostatic force is uniformly exerted on the vibrator 10, by which it is possible to precisely reproduce musical tone signals.

Since the vibrator 10 has a high rigidity compared with the planar vibrator, it is possible to easily assemble the electrostatic speaker 1 without forming lines and bags in the vibrator 10.

In order to produce the high sensitivity achieved by the vibrator 10 having the projections 11 and 12 by use of the planar vibrator (used in the conventionally-known electrostatic speaker), it is necessary to reduce the distance between the electrodes 20U and 20L. When the distance between the opposite electrodes 20 is reduced, the drive force applied to one electrode 20 due to audio signals may affect the other electrode 20, so that the electrodes 20 may be unexpectedly driven to vibrate so as to cause distortions in reproduction waves.

The present embodiment is designed such that the vibrator 10 has improved sensitivity due to the formation of the projections 11 and 12; hence, even when the distance between the opposite electrodes 20 is increased so that the opposite electrodes 20 are not driven to vibrate due to audio signals, it is possible to achieve a high sensitivity in vibration of the vibrator 10. Thus, it is possible to prevent distortions from occurring in emitted sounds by avoiding unexpected drive and vibration of the electrodes 20.

Since the vibrator 10 vibrates with a high sensitivity and produces a relatively large amplitude in comparison with the planar vibrator, it is possible to achieve a high sound pressure produced by the electrostatic speaker 1 compared with the conventionally-known electrostatic speaker of the same size even when the distance between the opposite electrodes 20 is increased.

The present embodiment can be further modified in a variety of ways; hence, variations will be described below.

In the present embodiment, the electrodes 20 are each composed of a rectangular plate-like material having a conductive property; but this is not a restriction. That is, they can each be composed of porous materials conductive properties such as wire nettings and conductive nonwoven fabrics.

The vibrator 10 can be formed using materials laminated with metal thin films or using insulating films which are polarized under high voltages.

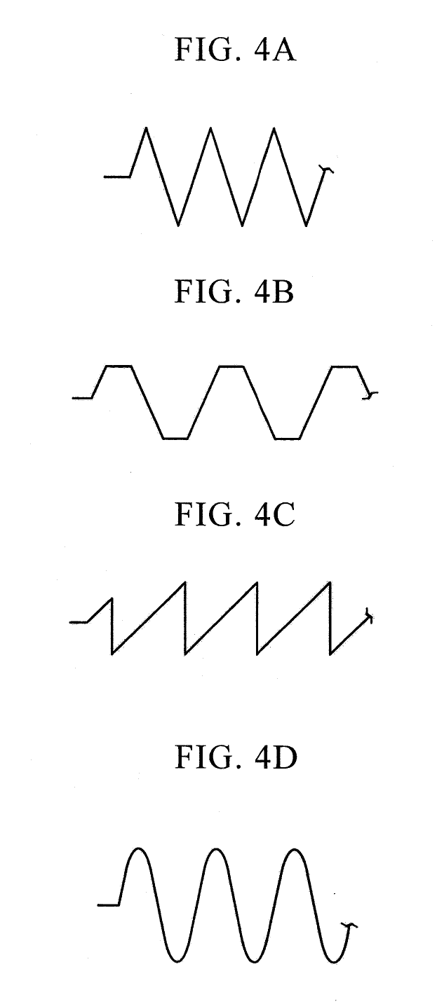

The shapes of the projections 11 and 12 of the vibrator 10 are not necessarily limited to square cube-like shapes, which can be varied in other shapes. For example, the projections 11 and 12 can each be formed in a conical shape whose cross section is shown in FIG. 4A. They can each be formed in a square shape along the X-Y plane and in a trapezoidal shape along the X-Z plane (or the Y-Z plane) as shown in FIG. 4B. They can each be formed in a saw-toothed shape along the X-Z plane as shown in FIG. 4C. Alternatively, they can each be formed in a circular shape in plan view and in a waveform-like shape along the X-Z plane as shown in FIG. 4D.

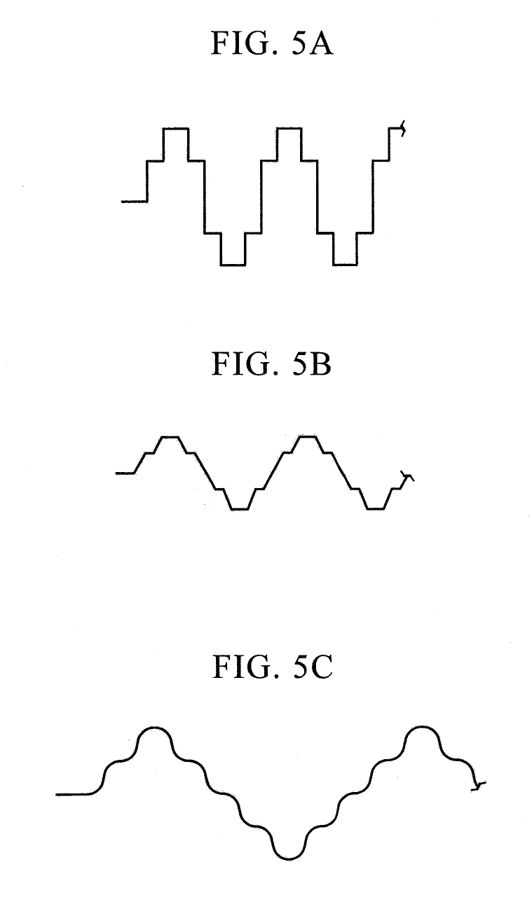

Alternatively, the projection 11 and 12 can each be formed in a square shape along the X-Y plane and in one of step-like shapes along the X-Z plane (or Y-Z plane) as shown in FIGS. 5A and 5B. They can each be formed in a circular shape along the X-Y plane and in a step-like shape along the X-Z plane (or the Y-Z plane) as shown in FIG. 5C.

It is preferable that the projections 11 and 12 have planar distal ends positioned in parallel to the electrodes 20U and 20L, thus further improving the sensitivity of the vibrator 10.

It is preferable that the projections 11 and 12 whose cross-sectional shapes are shown in FIGS. 4A, 4C, 4D, and 5C have planar distal ends positioned in parallel to the electrodes 20U and 20L.

The height of the surface projection 11 can differ from the height of the backside projection 12. However, it is preferable that both the surface projection 11 and the backside projection 12 have the same height.

In summary, the distances between the projections and the heights of the projections, which project in the Z-axis direction from the center of the vibrator 10, should be determined so as not to form lines and bags in the vibrator 10 even when no tension is applied to the vibrator 10 in manufacturing.

In the present embodiment, the peripheral portions of the vibrator 10 are supported by the spacers 30U and 30L, wherein the four sides of the peripheral portions of the vibrator 10 are supported by the spacers 30U and 30L; but this is not a restriction. That is, three sides, two sides, or one side of the peripheral portions of the vibrator 10 can be supported by the spacers 30U and 30L.

It is possible to modify the electrostatic speaker 1 as shown in FIG. 6, in which elastic members 40U and 40L both having the same thickness and composed of the same material having the elastic property are inserted between the vibrator 10 and the electrodes 20U and 20L. FIG. 6 shows that the elastic members 40U and 40L (referred to as elastic member 40) are partially embedded in the recesses formed by the projections 11 and 12 of the vibrator 10. It is possible to further modify the electrostatic speaker 1 as shown in FIG. 7, in which the elastic members 40 are not partially embedded in the recesses formed by the projections 11 and 12 of the vibrator 10.

It is preferable that the elastic members 40 have air transmittance, which is higher than the air transmittance of the electrodes 20, and be set to 95% or more of air transmittance, for example. The elastic members 40 can be composed of any types of materials having insulating properties such as sponges, sheets, and nonwoven fabrics.

By inserting the elastic members 40 between the vibrator 10 and the electrodes 20, it is possible to reliably support the vibrator 10 and to apply an appropriate elastic stress to the vibrator 10.

In the present embodiment, audio signals are supplied to both of the electrodes 20U and 20L sandwiching the vibrator 10 in the electrostatic speaker 1; however, it is possible to supply audio signals to one of the electrodes 20U and 20L. In this case, the electrode 20 not supplied with audio signals can be replaced with a rectangular plate-like member not having a conductive property. In summary, the electrostatic speaker 1 should be designed such that electrostatic force is exerted on the vibrator 10 in response to audio signals.

The vibrator 10 is not necessarily fixed to the spacers 30U and 30L, which are positioned opposite to each other. Alternatively, the vibrator 10 is simply held between the spacers 30U and 30L and is supported without tension applied thereto.

Lastly, the present invention is not necessarily limited to the present embodiment and variations and can be further modified in a variety of ways within the scope of the invention as defined in the appended claims.

What is claimed is:

1. An electrostatic speaker comprising:
a first electrode having conductive properties;
a second electrode having conductive properties, which is positioned opposite to the first electrode with a prescribed distance therebetween;
a vibrator inserted between the first electrode and the second electrode, wherein the vibrator has a plurality of first projections projecting towards the first electrode and a plurality of second projections projecting towards the second electrode; and
a support member for supporting the vibrator,
wherein each of the first projections has a polygonal cross-sectional shape or a closed-curve-like cross-sectional shape,
wherein each of the second projections has a polygonal cross-sectional shape or a closed-curve-like shape, and
wherein the plurality of first projections and the plurality of second projections are regularly aligned in connection with the vibrator.

2. An electrostatic speaker according to claim 1, wherein both of the first projections and the second projections have the same height.

3. An electrostatic speaker according to claim 1, wherein both of the first projections and the second projections have the same shape.

4. An electrostatic speaker according to claim 1, wherein the support member supports the vibrator without applying tension to the vibrator.

5. An electrostatic speaker according to claim 1, wherein a distance between the first electrode and a distal end of the first projection is identical to a distance between the second electrode and a distal end of the second projection.

6. An electrostatic speaker according to claim 1, wherein a first elastic member is inserted between the first electrode and the vibrator, and a second elastic member is inserted between the second electrode and the vibrator.

7. An electrostatic speaker according to claim 1, wherein the first projection has a planar distal end which is positioned in parallel to the first electrode, and the second projection has a planar distal end which is positioned in parallel to the second electrode.

8. An electrostatic speaker according to claim 7, wherein both the planar distal end of the first projection and the planar distal end of the second projection have the same area, and wherein the number of the first projections is identical to the number of the second projections.
